(19) United States
(12) Patent Application Publication
(10) Pub. No.: US 2023/0159026 A1
(43) Pub. Date: May 25, 2023

(54) Predicting Motion of Hypothetical Agents

(71) Applicant: Motional AD LLC, Boston, MA (US)

(72) Inventors: Yu Pan, Singapore (SG); You Hong Eng, Singapore (SG); Scott D. Pendleton, Singapore (SG); James Guo Ming Fu, Singapore (SG)

(21) Appl. No.: 17/531,701

(22) Filed: Nov. 19, 2021

(51) Int. Cl. B60W 30/095; B60W 60/00; B60W 40/04; G06K 9/00; G06K 9/32

(52) U.S. Cl. CPC B60W 30/0956; B60W 60/00274; B60W 60/0015; B60W 40/04; G06K 9/00805; G06K 9/3233; B60W 2554/40; B60W 2554/80

(57) ABSTRACT

Provided are methods for predicting motion of hypothetical agents, which can include receiving sensor data, generating a segmentation mask indicative of at least one occluded area, generating at least one hypothetical agent trajectory, determining at least one agent generation point, determining whether a threshold distance from the at least one agent generation point to the vehicle is satisfied, generating at least one agent, planning a path of the vehicle and controlling the vehicle according to the planned path. Systems and computer program products are also provided.

### BACKGROUND

Autonomous vehicles are operable in environments with one or more other agents, such as a pedestrian or a vehicle. An agent may suddenly emerge into the view of an autonomous vehicle. The sudden appearance of the agent can cause the autonomous vehicle to maneuver sharply to avoid collision with the agent. The sharp maneuver may be dangerous or disturb the passengers in the autonomous vehicle.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 is a block diagram of an implementation of a process for predicting motion of hypothetical agents.

FIG. 6A is a process for generating and updating pedestrian-like hypothetical agents.

FIG. 6B is a graph illustrating probabilities associated with occlusion region transitions.

FIG. 7 is a process for determining agent generation points for vehicle-like hypothetical agents.

FIG. 8 is a flowchart of a process for predicting motion of hypothetical agents.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Some embodiments of the present disclosure are described herein in connection with a threshold. As described herein, satisfying a threshold can refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

In some aspects and/or embodiments, systems, methods, and computer program products described herein include and/or implement predicting the motion of hypothetical agents. The existence and motion of a hypothetical agent (e.g., a pedestrian or a vehicle) is predicted based in part on features of an object occluding the hypothetical agent. In general, a vehicle can predict that an agent exists behind an occlusion and generate possible trajectories for the agent in order to prepare for scenarios in which the agent exists in-fact and needs to be avoided (e.g., to prevent a collision with an agent that appears suddenly from behind the occlusion). If the occlusion is “open” (e.g., the occlusion has an entry point and exit point visible to the vehicle) then the vehicle can more accurately predict constraints on the hypothetical agent's motion. For example, it is likely that an agent is not traveling at a high velocity behind an open occlusion unless it was visible to the vehicle before passing behind the open occlusion.

By virtue of the implementation of systems, methods, and computer program products described herein, techniques for predicting motion of hypothetical agents have the following advantages. A distribution of motion profiles for agents ensures more realistic constraints for the vehicle to avoid colliding with the agents, if they exist. Anticipating agents in unobservable regions enables the vehicle to operate more safely. Agents are generated only when the vehicle is within a distance of the hypothetical paths of the agent, allowing the vehicle to save computational resources. Two classes of agents (e.g. pedestrians and vehicles) introduced enable the vehicle to plan its path less prone to collision.

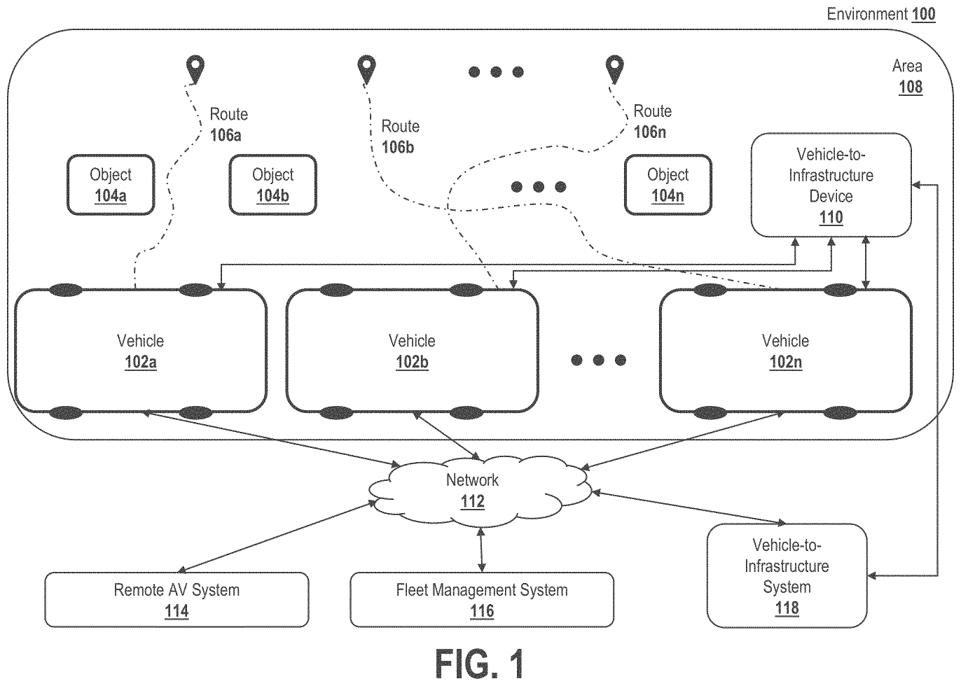

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

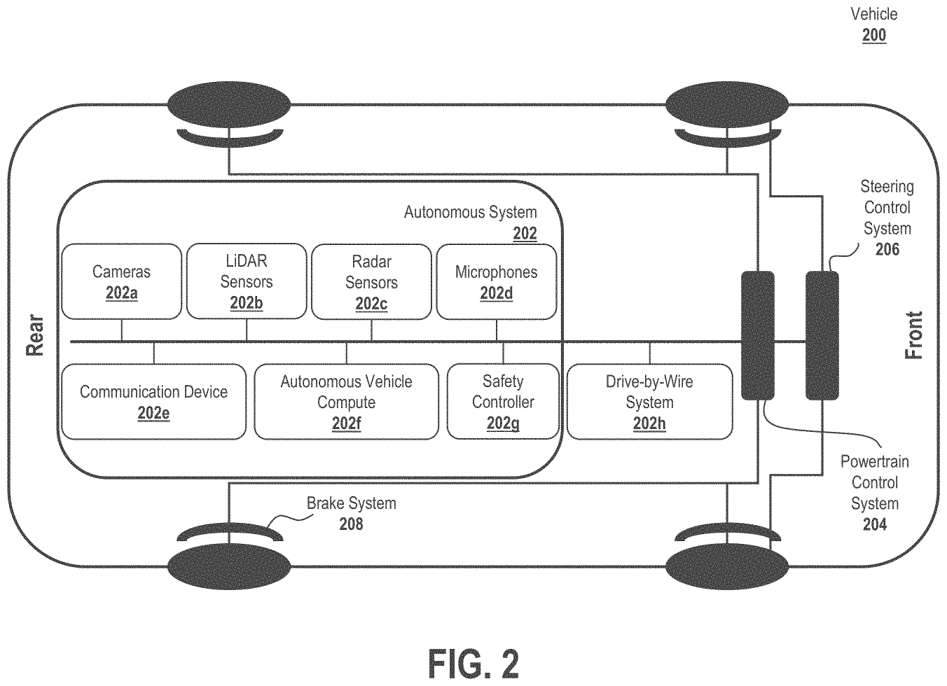

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited look-ahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

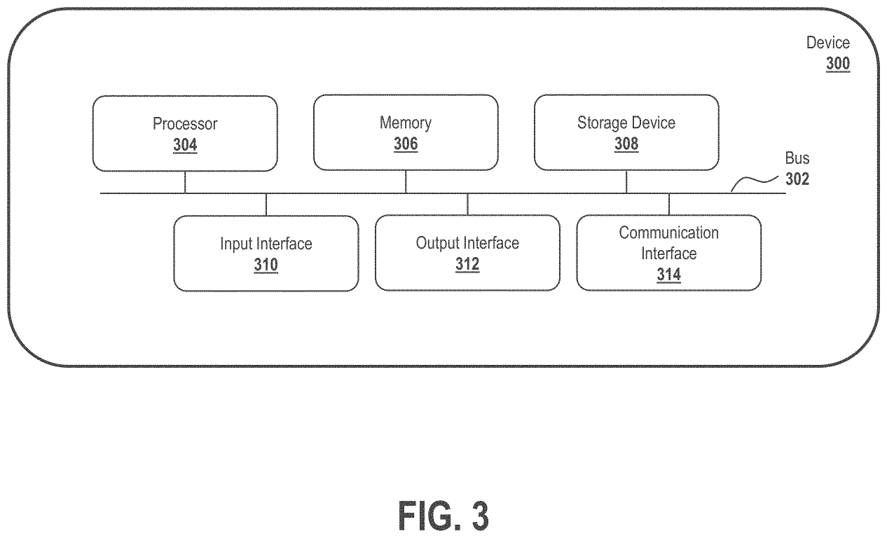

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In some embodiments, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of vehicles 200 (e.g., at least one device of a system of vehicles 200), and/or one or more devices of network 112 (e.g., one or more devices of a system of network 112). In some embodiments, one or more devices of vehicles 102 (e.g., one or more devices of a system of vehicles 102), one or more devices of vehicles 200 (e.g., one or more devices of a system of vehicles 200), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 306 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

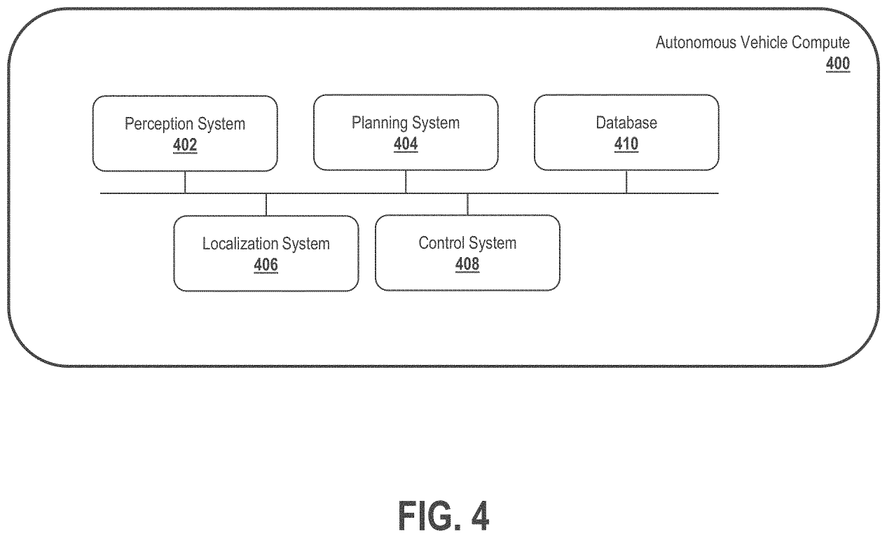

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments, perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406, and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

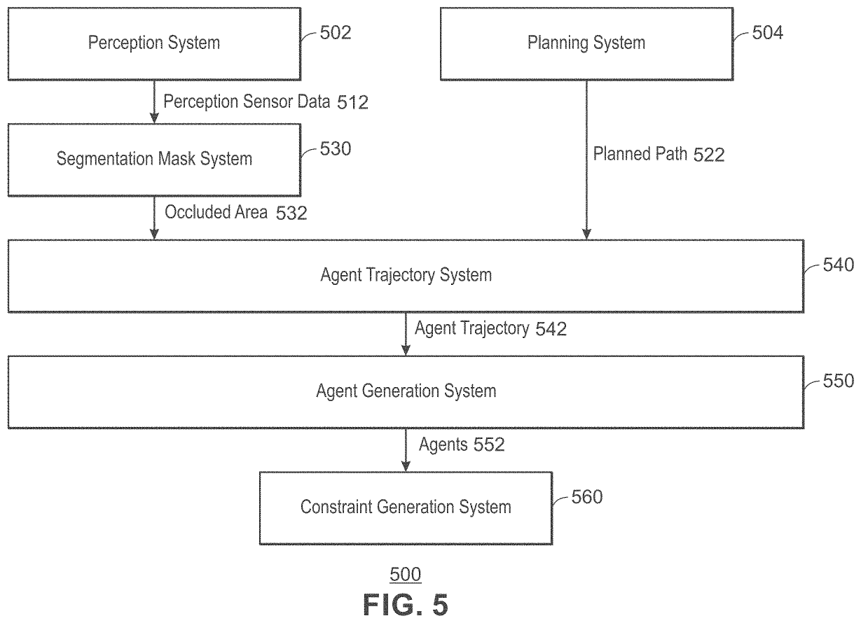

Referring now to FIG. 5, illustrated is an example block diagram of a system 500 for predicting motion of hypothetical agents. The system 500 imposes constraints on the operation, motion, or behavior of the vehicle in response to open occlusions. In some cases, the constraints induce more conservative and safe operation or maneuvers. Generally, a constraint on the vehicle is a limit or modification of the vehicle operation, motion, or behavior of the vehicle. In embodiments, the present techniques apply constraints to a vehicle in response to hypothetical agents. Generally, a hypothetical agent is an agent which is postulated to exist even though it is unobservable (e.g., undetected by sensors 202 of FIG. 2). If the vehicle were to observe an agent appearing out of the occlusion close to a hypothetical agent, it would essentially validate the hypothesis that there was an unseen agent blocked by the occlusion. Conversely, observing that the previously occluded area where a hypothetical agent was placed is unoccupied invalidates the hypothesis that there was an unseen agent blocked by the occlusion, where the occluded area is newly observable after progressing along a planned trajectory.

An occluded area is an area unobservable by a vehicle (e.g., an area blocked from sensor view by a parked vehicle, an area outside the sensor range of a sensor associated with the system 500, etc.). In some embodiments, the vehicle is an autonomous vehicle. In such embodiments, the autonomous vehicle is similar to or the same as the vehicle 200 shown in FIG. 2. In some embodiments, the system 500 includes a perception system 502, planning system 504, segmentation mask system 530, agent trajectory system 540 and agent generation system 550. In some embodiments, the planning system 504 is the same as, or similar to, a part of the planning system 404 of FIG. 4. In some embodiments, the planning system 504 is a standalone external, or backup, planning system (e.g., a planning system that is included in a control system that is the same as, or similar to, control system 408, and/or the like). Similarly, in some embodiments, the perception system 502 is the same as, or similar to, a part of the perception system 402 of FIG. 4. In some embodiments, the perception system 502 is a standalone external, or backup, perception system (e.g., a planning system that is included in a control system that is the same as, or similar to, control system 408, and/or the like).

In some embodiments, the system 500 executes via the processor 304 shown in FIG. 3. In some embodiments, the system 500 uses a remote processor in a cloud computing environment. In some embodiments, perception system 502, planning system 504, segmentation mask system 530, agent trajectory system 540 and agent generation system 550 may be the same as, or similar to, device 300 of FIG. 3 (e.g., may include one or more components that are the same as, or similar to, one or more components of device 300).

Perception system 502 generates perception sensor data 512. In some embodiments, perception system 502 includes cameras 202a, LiDAR sensors 202b and/or radar sensors 202c shown in FIG. 2. The perception system 502 can include additional sensors such as sonars, haptic devices and/or the like. In some embodiments, perception sensor data 512 includes camera data, LiDAR data or radar data. More generally, perception sensor data 512 is data representative of the surrounding environment of the vehicle. Perception sensor data 512 is provided as input to a segmentation mask system 530. The segmentation mask system 530 generates a segmentation mask indicating the position of at least one occluded area 532, if any, based on the perception sensor data 512. A segmentation mask is an image marking regions of interest. For example, in a segmentation mask, pixels corresponding to similar objects are assigned the same label. In such an example, in the segmentation mask, pixels corresponding to vehicles are labeled as 1 and pixels corresponding to roads are labeled as 2. Some example segmentation masks can be found in the discussion below. In some embodiments, the segmentation mask system 530 is a part of the perception system 502 or the localization system 406.

In some embodiments, the segmentation mask system 530 generates the segmentation mask by comparing a maximum sensor range with the received perception sensor data 512. In such embodiments, the segmentation mask may be represented as a bird-eye view of the surroundings of the vehicle. In some embodiments, cells (e.g., pixels, groups of pixels, and/or the like) of the segmentation mask corresponding to areas within the maximum sensor range but not populated by sensor data points are labeled as occluded areas. In such embodiments, the segmentation mask is a 2D binary image showing pixels in an occluded area 532 as 1, and pixels in not occluded areas as 0.

In some embodiments, the segmentation mask indicating the occluded area 532 includes locational information about the occluded area 532, such as whether the occluded area 532 is on-road (e.g., a drivable road, etc.) or off-road (e.g., a sidewalk, an unpaved area, an open field, etc.). In such embodiments, the segmentation mask is a 2D ternary image showing pixels in an on-road occluded area 532 as 1, pixels in an off-road occluded area 532 as 2, and pixels in not occluded areas as 0. Alternatively or additionally, in such embodiments, the pixels corresponding to a lane center (e.g., center of a travel lane) in an on-road occluded area 532 segmentation mask are given a different label (e.g., 4).

In some embodiments, the segmentation mask system 530 applies a smoothing algorithm to the segmentation mask. The smoothing algorithm enables the occluded area 532 to have a smoother and more realistic border. In some embodiments, the segmentation mask system 530 can use the smoothing algorithm to update pixels of the segmentation mask.

An agent trajectory system 540 generates agent trajectories 542 for different types of agents based on an initial trajectory 522 of the vehicle and/or the occluded area(s) 532 indicated on the segmentation mask. The initial trajectory 522 is received from the planning system 504 and is a reference trajectory for the vehicle to follow. Generally, a trajectory refers to sequence of timestamped poses. The sequence of timestamped poses includes a velocity profile is also conveyed in addition to spatial location. The spatial location associated with the trajectory is used to generate trajectories for one or more hypothetical agents at the agent trajectory generation system 540. At the constraint generation system 560, the temporal information associated with the initial trajectory is evaluated to determine constraints on the vehicle and a final, executed trajectory is modified from the initial trajectory 522 to avoid collisions with the agent trajectories.

In examples, the initial trajectory 522 is a predetermined trajectory generated based on data observed in the surrounding environment and a predetermined destination. For example, trajectories for hypothetical agents that are pedestrians are generated as constant heading paths orthogonal to and directed towards the initial trajectory 522. Put another way, pedestrians that are hypothetical are assumed to approach the initial trajectory by a shortest possible path from a nearest section of the occluded area. The nearest section of the occluded area is a nearest section that is large enough to occlude a pedestrian. In embodiments, the agent trajectory system spawns one hypothetical pedestrian trajectory for every occlusion. For example, where a number of parked cars occlude an area, the one pedestrian (e.g., hypothetical agent) is hypothesized to emerge from behind each parked car along a trajectory being navigated by the vehicle.

In some embodiments, the agent trajectories 542 generated are open occlusion trajectories. An open occlusion trajectory is a trajectory of a hypothetical agent that contains at least one pair of occlusion entry and occlusion exit. In other words, an open occlusion trajectory contains a segment in the occluded areas 532, and two ends (e.g., the occlusion entry and occlusion exit) located at the boundary of the occluded areas 532. The occlusion entry is the point where the hypothetical agent enters the occluded area 532 and the occlusion exit is the point where the hypothetical agent emerges from the occluded area 532 and re-enters an area observable by the vehicle. In some embodiments, the occlusion exit is closer to the vehicle than the occlusion entry.

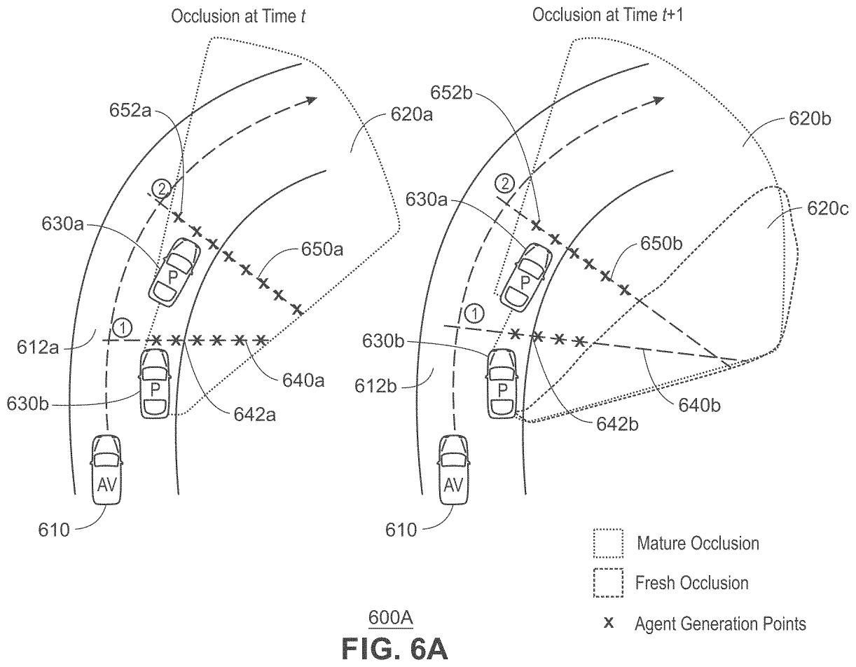

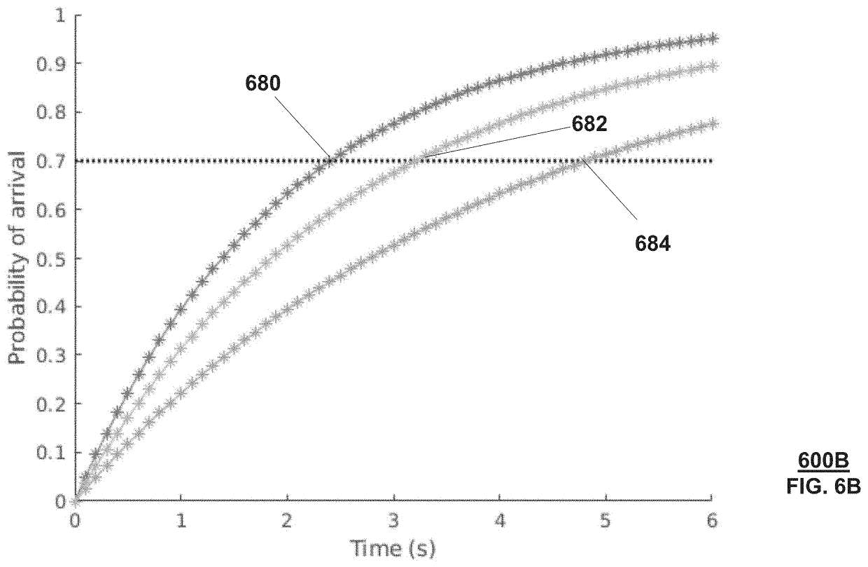

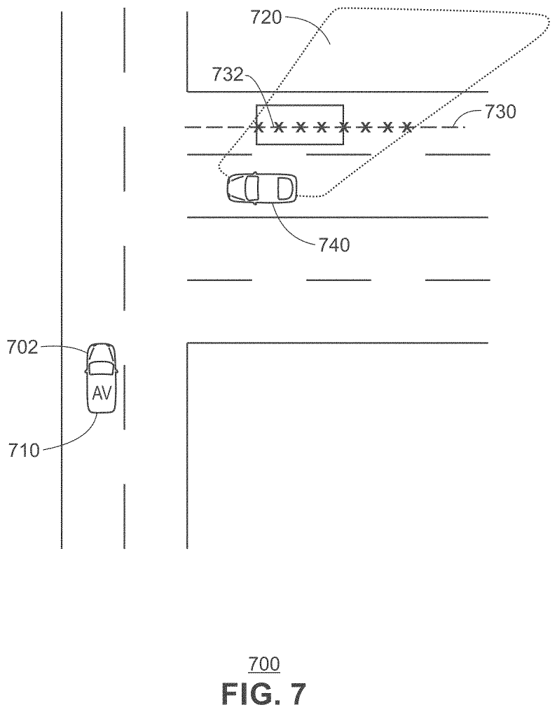

In some embodiments, the agent trajectories 542 are based on, at least in part, an agent type. As discussed above, the segmentation mask includes locational information about the occluded area 532, such as whether the occluded area 532 is on-road (e.g., a drivable road, etc.) or off-road (e.g., a sidewalk, an unpaved area, an open field, etc.). When the occluded area 532 is on-road and large enough to fit a standard size car positioned along the center of the lane, then trajectories are generated for vehicles as hypothetical agents. When the occluded area 532 is either on-road or off-road and large enough to fit a standard size pedestrian, then trajectories are generated for pedestrians as hypothetical agents. In examples, other factors are considered when determining an agent type for the generation of agent trajectories. For example, the generated agent trajectories could be based on pedestrians as hypothetical agents in an off-road occluded area known for pedestrian jaywalker traffic, or near crosswalks. Details regarding generating the agent trajectories 542 for different types of agents is discussed below in FIGS. 6 and 7.

The agent generation system 550 takes as input an agent trajectory 542 and generates a distribution of agents 552. In some embodiments, the agent generation system 550 determines discretized agent generation points with a pre-determined resolution (e.g., 5 meters apart) along the agent trajectory 542. An agent generation point is a discretized location on the agent trajectory where a hypothetical agent is generated. For example, for each agent generation point, a distribution of agents 552 (e.g., simulated agents) with different motion profiles (e.g., velocity of 0 ms⁻¹, 0.5 ms⁻¹, . . . , 2 ms⁻¹ with or without acceleration of −0.5 ms⁻², 0, 0.5 ms⁻²) are generated by the agent generation system 550. In an example, a positive velocity of an agent indicates that the agent is moving towards the vehicle. The different motion profiles can be generated based on the distribution of agents. For example, the different motion profiles are generated based on a Gaussian distribution of agents. In some embodiments, agents moving away from the vehicle are disregarded (e.g., removed or deconstructed by the agent generation system 550) to save computational resources.

In some embodiments, each agent generation point is used to generate agents 552 once. For example, the agent generation points are used to generate agents 552 when a threshold distance from the agent generation points to the vehicle is satisfied. Additionally, the agent generation points are used to generate agents 552 when a threshold distance from a nearest point of the occluded area to the vehicle is satisfied. In embodiments, the threshold distance is predetermined, such as 500 meters. In embodiments, the threshold distance is calculated based on the ranges of the perception system 502 (e.g., using a logistic regression model). In some embodiments, some agent generation points are repetitively used to generate recurring agents 552. Details regarding generating agents in some example scenarios are discussed below in FIGS. 6 and 7.

The agents 552 are provided as input to a constraint generation system 560. In examples, hypothetical agents traveling towards the vehicle or a planned path of the vehicle are associated with stricter constraints on the behavior of the vehicle. In examples, the direction of travel for a hypothetical agent such as a pedestrian is assumed to be perpendicular to the AV path. Generally, this represents a worst-case scenario where the hypothetical agent could intercept the path of the AV and cause a collision. Stricter constraints on the vehicle behavior include a limitation on the vehicle behavior during the time that the occluded area is observed. In examples, the constraint generation system 560 generates constraints based on a likelihood of the constraint in preventing a collision with a hypothetical agent. The constraints are applied to govern vehicle functionality using one or more systems that enable operation of the vehicle. For example, one or more constraints are obtained by a control system or planning system and applied to vehicle functions.

A control system can apply limitations to velocity, steering, throttling, braking, and the like. In the example with hypothetical agents traveling toward the vehicle, the control system can apply limits to command velocity to avoid a scenario where the hypothetical agent collides with the vehicle. Contrarily, agents traveling away from the vehicle or a planned path of the vehicle have lower likelihoods of intersecting or interfering with the vehicle's planned path and, as a result, less strict constraints on the behavior of the vehicle are imposed. In an example with hypothetical agents traveling away from the vehicle, limits on vehicle behavior are unnecessary as the hypothetical agents are moving away from the vehicle's path. An example of a constraint is an increase or reduction in speed (including coming to a complete stop), a lateral clearance threshold which could result in change of path, and the like. Some example open occlusion trajectories can be found below in FIGS. 6A and 7.

In an example, a planning system can apply limitations to the initial trajectory based on, at least in part, constraints from the constraint generation system 560. In embodiments, the agents 552 are provided to a planning system, such as planning system 504 or planning system 404 of FIG. 4. In some embodiments, the agents 552 introduce constraints on the vehicle behavior as determined by the constraint generation system 560 and the planning system evaluates the impact of the agents on the planned path. The planning system updates the path or trajectory for the vehicle such that the vehicle will maneuver to avoid colliding with the agents. In some embodiments, the updated path or trajectory is used to control the vehicle by a control system 408.

Referring now to FIG. 6A, illustrated is an example scenario 600 for generating and updating hypothetical agents. In the example scenario 600, the hypothetical agent is a simulated pedestrian. In embodiments, the updating is performed in discrete time, where hypothetical agents could be updated upon every perception update (the update time step equivalent to delay between successive observations), or less frequently. The following discussion presents two time steps, t and t+1. Time t can represent a previous time step while time t+1 a current time step. However, time t and time t+1 can represent any time step and a time step right after (e.g., a present time step and a future time step).

At time t, a vehicle 610 has a planned vehicle path 612a. In some embodiments, the planned vehicle path 612a is generated at a previous time. In some embodiments, the vehicle 610 is a vehicle 200 which contains the system 500, and the planned vehicle path 612a is an example initial trajectory 522. The occlusion region 620a is blocked from the observation of the vehicle 610 by two parked vehicles 630a and 630b. The occlusion region 620a is an example occluded area 532. In some embodiments, the occlusion region 620a is a mature occlusion region. A mature occlusion region is a region that is not observable by a vehicle for a sufficiently long duration, and is highly probable to contain unseen objects (e.g., pedestrians, bicyclists and/or the like). An example of a mature occlusion region includes a region that is occluded by a bus, a barrier, a trolley, and/or the like.

The vehicle 610 recognizes the occlusion region 620a through indications on the segmentation mask generated by the segmentation mask system 530 of the vehicle 610. In some embodiments, the maturity of occlusion is maintained for each cell on the segmentation mask. In some embodiments, the occlusion region 620a indicated on the segmentation mask does not include part of a drivable road. For example, a mature occlusion is an occlusion that is occluded for greater than a threshold duration of time.

In examples, the occlusion region transitions from being observable, to a fresh occlusion, to a mature occlusion, and back to an observable occlusion according to a statistical model. The statistical model describes the probability that a region is occupied by a pedestrian, bicycle, or vehicle. In embodiments, the statistical model is a Poisson Process. A Poisson Process is a model for a series of discrete event where the average time between events is known, but the exact timing of events is random. In the example of FIG. 6A, assume that on a weekday morning, sunny day, there is on average, a pedestrian crossing the street every 10 seconds. Then, the probability of the area occupied by one or more pedestrians is:

$$P ( T < t ) = 1 - {e}^{- λ * t}$$

$$where$$

$$λ = \frac{a r rival of pedestrians in a region}{10 seconds} = 0.1 events / second$$

FIG. 6B illustrates the probability for three different lambda values. The probability trends to 1 at a faster rate for larger lambda values. In examples, an occluded area is mature when the probability is greater than 0.7 (70%) for example. In the example of FIG. 6B, the transition time required for these lambda values are 2.4 s, 3.2 s and 4.8 s respectively.

Referring again to FIG. 6A, the agent trajectory system 540 of the vehicle 610 generates trajectories 640a and 650a for a hypothetical agent based on the occlusion region 620a. In this example, the simulated agent is a pedestrian, and hypothetical agent trajectories 640a and 650a are open occlusion trajectories. The trajectories 640a and 650a extend from within the occlusion region 620a towards the planned vehicle path 612a. The directions of the trajectories 640a and 650a indicate the positive directions of the velocities and accelerations of hypothetical agents traveling along the trajectories 640a and 650a. In some embodiments, the trajectories 640a and 650a are perpendicular to the planned vehicle path 612a to represent the shortest trajectories traveled by hypothetical pedestrian-like agents towards the vehicle 610. In some embodiments, both trajectories 640a and 650a have occlusion entries and occlusion exits in the area observable by the vehicle 610.

Given the trajectories 640a and 650a, the agent generation system 550 of the vehicle 610 determines discretized agent generation points along the trajectories 640a and 650a. An example agent generation point along the trajectory 640a is point 642a and another example agent generation point along the trajectory 650a is point 652a. Since both point 642a and point 652a are in the occluded region 620a, the agents generated at point 642a or point 652a are hypothetical agents.

When the vehicle 610 is within a threshold distance from an agent generation point (e.g., point 642a or point 652a), the agent generation system 550 uses the point within the threshold distance to generate a distribution of agents with varying motion profiles. For example, at time t, point 642a is within the threshold distance from the vehicle but point 652a is not, the agent generation system 550 uses point 642a but not point 652a to generate agents. In some embodiments, the varying motion profiles used to generate agents are from a distribution function (e.g., a Gaussian distribution). Agents generated will be propagated into a later time (e.g., time t+1) according to the respective motion profiles. The agents generated are provided to the planning system 404 of the vehicle 610 to update the planned vehicle path 612a such that the vehicle 610 will avoid colliding with the agents in a future time (e.g., at time t+1).

In some embodiments, the vehicle 610 follows the planned vehicle path 612a and, at time t+1, has a current state (e.g., a new pose, a new position or a new orientation at time t+1). Some previously occluded space becomes observable by the vehicle 610 while some previously observable area becomes occluded. In an example, occluded region 620b is a previously occluded space that remains occluded, and is a mature occlusion region. In an example, occluded region 620c was observable by the vehicle at time t, but is not at time t+1, and is recently occluded. Occluded region 620c is called a fresh occlusion region. A fresh occlusion region represents areas that the vehicle 610 has observed recently, and is highly unlikely to contain unseen objects. In some embodiments, a threshold duration is used to distinguish between a fresh occlusion region and a mature occlusion region. For simplicity, in the following discussion, the threshold duration is one time step. For example, occluded region 620c, a fresh occlusion region at time t+1, will become a mature occlusion region at the next time step (e.g., time t+2).

At time t+1, the planning system 404 of the vehicle 610 generates a new planned vehicle path 612b based on information at time t, including the agents generated at time t. In some embodiments, the new planned vehicle path 612b is followed by the vehicle until the next time step (e.g., time t+2). The new planned vehicle path 612b can be updated based on later information, similar to updating the planned vehicle path 612a. In some embodiments, the new planned vehicle path 612b is a part of the current state of the vehicle 610.

Given the occluded regions 620b and 620c at time t+1, the agent trajectory system 540 of the vehicle 610 generates new open occlusion trajectories for a pedestrian-like hypothetical agent. Two example new occlusion trajectories 640b and 650b, which are perpendicular to the new planned vehicle path 612b. In some embodiments, new occlusion trajectories 640b and 650b are generated by updating the trajectories 640a and 650a via computing new positions of trajectories 640a and 650a based on the current state of the vehicle 610.

The agent generation system 550 of the vehicle 610 takes the new occlusion trajectories 640b and 650b and determines several new, discrete agent generation points. Two example new agent generation points are point 642b along trajectory 640b and point 652b along trajectory 650b. In some embodiments, the new agent generation points are only in the mature occlusion region 620b but not in the fresh occlusion region 620c, because the fresh occlusion region 620c has been observed by the vehicle 610 to have been unoccupied recently and should not spawn hypothetical agents.

In some embodiments, the current state of the vehicle 610 is used to determine whether the new agent generation points 642b and 652b correspond to the agent generation points 642a and 652a. In an example data association process, the current state of the vehicle 610 is used at the agent generation system to calculate an updated position for the agent generation point 642a based on the relative positions at time t of the vehicle 610 and the point 642a. If the updated position for the agent generation point 642a is within a small threshold distance of the new agent generation point 642b, the points 642a and 642b correspond to each other.

For simplicity, the following discussion assumes the point 642b corresponds to point 642a and the point 652b corresponds to point 652a. At time t+1, the vehicle 610 is assumed to satisfy the threshold distance from the points 642b and 652b. In some embodiments, since point 642a has been used at time t to generate agents, point 642b is not used to generate agents at time t+1. In this case, only point 652b is used by the agent generation system 550 to generate agents that follow trajectory 650b. This disallows duplicate sets of agents and ensures the agent generation process is efficient regarding computational resources of vehicle 610. In some embodiments, the correspondence between agent generation points, such as the correspondence between point 642a and point 642b, ensures that each agent generation point is used only once to generate agents, even in different time (e.g., in different time steps).

In some embodiments, the agent generation system 550 determines some agent generation points near the boundaries of the occluded regions (e.g., the occluded region 620a or the union of the occluded regions 620b and 620c) to generate recurring agents. The recurring agents represent inattentive pedestrian-like agents (e.g., an inattentive pedestrian, a skater skating near the road or a cyclist going in circles). Each recurring agent generation point can be used to generate a distribution of recurring agents as well. The recurring agent generation points can be used to establish correspondence using the example data association process described above.

At time t+1, the agent generator updates positions and velocities of the agents generated at time t. An agent generated at time t following its motion profile has an updated position and an updated velocity at time t+1. In some embodiments, if the hypothetical agent stays in the observable area by the vehicle 610 for a sufficient amount of time (e.g. 0.3 seconds), the hypothetical agent is removed from future updates via the agent generation system 550 deleting or deconstructing the agent. In some embodiments, the amount of time is defined in terms of a number of time steps (e.g., the next 5 time steps). This delay can mitigate uncertainties in perception around the occlusion boundaries. Faster hypothetical agents will enter the visible region earlier, and typically impose greater constraints, but they will also be terminated earlier. The agents which survive for a longer time within the occluded area represent lagging effects or slightly slower pedestrian-like agents (e.g., cyclists, skaters and/or pedestrians). The deletion or deconstruction of agents frees memory space and computational resources of the vehicle 610.

In some embodiments, agents with negative velocities are removed from future updates if the agents have negative velocities for a sufficient amount of time. The agents with negative velocities represent pedestrians moving away from the path of the vehicle 610 and hence impose much less strict constraints on the behavior of the vehicle 610. Removing these agents from future updates also frees memory space and computational resources of the vehicle 610.

Referring now to FIG. 7, illustrated is an example scenario 700 for determining agent generation points for hypothetical agents that are simulated vehicles. In some embodiments, generating and updating hypothetical agents that are simulated vehicles is the same as or similar to generating and updating pedestrian-like hypothetical agents described above. In some embodiments, the process 700 is performed by a vehicle 710. In some embodiments, vehicle 710 is vehicle 200 which contains the system 500. In some embodiments, vehicle 710 is the same as or similar to vehicle 610.

In embodiments, an autonomous system 702 of vehicle 710 (which is the same as, or similar to, autonomous system 202 of FIG. 2), recognizes the occlusion region 720 blocked by another on-road vehicle 740 through indications on the segmentation mask generated by the segmentation mask system 530 of the vehicle 710. In some embodiments, the occlusion region 720 indicated on the segmentation mask includes part of a drivable road. The drivable road includes a lane center 730. In some embodiments, the lane center 730 is a center of a travel lane included on the drivable road.

The system 702 of vehicle 710 recognizes in the occlusion region 720 the lane center 730. The recognition is based on indications on the segmentation mask, or based on interpolation or extrapolation of the environment reconstructed using perception sensor data 512, or both.

The agent trajectory system 540 of the vehicle 710 generates new open occlusion trajectories for hypothetical agents that are simulated vehicles based on the lane center 730. An example open occlusion trajectory is along the lane center 730. In some embodiments, the open occlusion trajectory extends towards the vehicle 710 regardless of the direction of travel. In such embodiments, the vehicle-like agents can represent vehicles with abnormal behaviors (e.g., retrograding, reversing and/or the like).

The agent generation system 550 of the vehicle 710 takes the new occlusion trajectories and determines discrete agent generation points along the open occlusion trajectories. An example agent generation point for a hypothetical agent that is a simulated vehicle is point 732 along the lane center 730. In some embodiments, the agent generation system 550 determines some agent generation points near the boundaries of the drivable road segment of the occluded region 720 to generate recurring simulated vehicles as hypothetical agents.

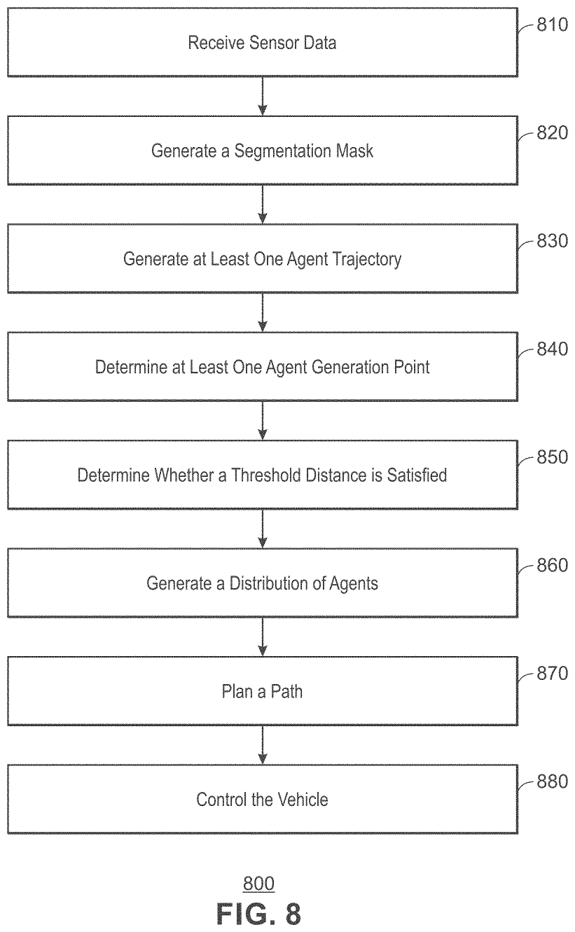

Referring now to FIG. 8, illustrated is a flowchart of an example process 800 for predicting motion of hypothetical agents. In some embodiments, one or more of the steps described with respect to process 800 are performed (e.g., completely, partially, and/or the like) by the processor 304 of vehicle 610 and/or vehicle 710. Additionally, or alternatively, in some embodiments one or more steps described with respect to process 800 are performed (e.g., completely, partially, and/or the like) by another device or group of devices separate from or including the processor 304 such as remote processor in a cloud computing environment.

With continued reference to FIG. 8, sensor data indicative of the environment surrounding a vehicle is received (block 810). For example, the sensor data indicative of the environment surrounding the vehicle may be received by a system of a vehicle (e.g., a system of a vehicle that is the same as, or similar to, vehicle 610 and/or vehicle 710). In some embodiments, the sensor data is the perception sensor data 512 generated from the perception system 502 shown in FIG. 5. In some embodiments, the vehicle is the vehicle 610 shown in FIG. 6A. In some embodiments, the vehicle is the vehicle 710 shown in FIG. 7.

With continued reference to FIG. 8, a segmentation mask indicative of at least one occluded area is generated (block 820). In some embodiments, the segmentation mask is generated by the segmentation mask system 530 shown in FIG. 5. In some embodiments, the at least one occluded area is the occluded area 532 shown in FIG. 5. In some embodiments, the at least one occluded area indicated on the segmentation mask from a previous time is updated based on a current state of the vehicle. In such embodiments, the updated at least one occluded area is one of the occluded regions 620b-c. In some embodiments, at least one recurring agent generation point is determined to be near (e.g., within) the boundary of the at least one occluded area.

With continued reference to FIG. 8, at least one hypothetical agent trajectory in the at least one occluded area on the segmentation mask is generated (block 830). In some embodiments, the at least one hypothetical agent trajectory is generated by the agent trajectory system 540 shown in FIG. 5. In some embodiments, the at least one hypothetical agent trajectory is an open occlusion trajectory. In some embodiments, the at least one hypothetical agent trajectory is based on or perpendicular to a planned path of the vehicle, such as the open occlusion pedestrian-like hypothetical agent trajectories 640a and 650a. In some embodiments, the at least one hypothetical agent trajectory is based on or along a center of a travel lane, such as the open occlusion vehicle-like hypothetical agent trajectory along the lane center 730. In some embodiments, the at least one hypothetical agent trajectory is updated based on updating the at least one occluded area and a planned path of the vehicle. In such embodiments, the updated at least one hypothetical agent trajectory is one of the open occlusion pedestrian-like hypothetical agent trajectories 640b and 650b.

With continued reference to FIG. 8, at least one agent generation point along the at least one agent trajectory is determined (block 840). In some embodiments, the at least one agent generation point is generated by the agent generation system 550 shown in FIG. 5. In some embodiments, at least one updated agent generation point is determined based on the updated at least one agent trajectory. In such embodiments, the at least one updated agent generation point is one of point 642b and point 652b. In some embodiments, that the at least updated one agent generation point does not correspond to a previously used agent generation point is determined. In such embodiments, point 642b corresponds to a previously used agent generation point 642a and is not used again.

With continued reference to FIG. 8, whether a threshold distance from the at least one agent generation point to the vehicle is satisfied is determined (block 850). In some embodiments, the threshold distance from the at least one agent generation point to the vehicle is predetermined. In some embodiments, the threshold distance from the at least one agent generation point to the vehicle is calculated based on the sensing range of the sensors mounted on the vehicle.

With continued reference to FIG. 8, at least one agent that is associated with at least one motion profile is generated based on the at least one agent generation point, based on determining that the predefined threshold distance is met (block 860). In some embodiments, the at least one agent is from a distribution of agents. In some embodiments, the agents generated are the agent 552 shown in FIG. 5. In some embodiments, the at least one agent generation point is one of the agent generation points 642a-b, 652a-b or 732 shown in FIGS. 6 and 7. In some embodiments, at least one recurring agent associated with at least one motion profile is generated based on determining the at least one recurring agent generation point. In some embodiments, a position and a velocity of a generated agent are updated based on its motion profile. In such embodiments, an agent which enters an area observable by the vehicle for a sufficient amount of time, relative to a predetermined threshold, will be removed from future updates.

With continued reference to FIG. 8, a path of the vehicle is planned in reaction to the at least one agent (block 870). In some embodiments, the path of the vehicle is planned by the planning system 404 to avoid colliding with the at least one agent. In some embodiments, the path planned is the one of the planned vehicle paths 612a-b.

With continued reference to FIG. 8, the vehicle is controlled according to the planned path (block 880). In some embodiments, the vehicle is controlled by the control system 408.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method, comprising:
receiving, using at least one processor, sensor data indicative of the environment surrounding a vehicle;
generating, using the at least one processor, a segmentation mask indicative of at least one occluded area;
generating, using the at least one processor, at least one hypothetical agent trajectory based on the at least one occluded area;
determining, using the at least one processor, at least one agent generation point based on the at least one agent trajectory;
determining, using the at least one processor, whether a threshold distance from the at least one agent generation point to the vehicle is satisfied;
generating based on the at least one agent generation point, using the at least one processor, at least one agent that is associated with at least one motion profile based on determining that the predefined threshold distance is satisfied;
planning, using the at least one processor, a path of the vehicle based generating the at least one agent; and
controlling, using the at least one processor, the vehicle according to the planned path.

2. The method of claim 1, further comprising:
updating the at least one occluded area indicated on the segmentation mask from a previous time, based on a current state of the vehicle;
updating the at least one agent trajectory based on updating the at least one occluded area and an initial trajectory of the vehicle;
determining at least one updated agent generation point based on the updated at least one agent trajectory; and
determining that the at least updated one agent generation point does not correspond to a previously used agent generation point.

3. The method of claim 1, further comprising:
determining at least one recurring agent generation point near the boundary of the at least one occluded area; and
generating at least one recurring agent associated with at least one motion profile based on determining the at least one recurring agent generation point.

4. The method of claim 1, further comprising:
updating a position and a velocity of a generated agent based on its motion profile.

5. The method of claim 4, further comprising:
determining that an agent enters an area observable by the vehicle for a sufficient amount of time; and
removing the agent from future updates based on determining that the agent enters an area observable by the vehicle for a sufficient amount of time.

6. The method of claim 1, wherein the threshold distance is calculated based on the sensing range of the sensors mounted on the vehicle.

7. The method of claim 1, wherein the at least one agent trajectory is an open occlusion trajectory.

8. The method of claim 1, wherein the at least one agent trajectory is generated based on an initial trajectory of the vehicle.

9. The method of claim 8, wherein the at least one agent trajectory is perpendicular to the initial trajectory of the vehicle.

10. The method of claim 1, wherein the at least one agent trajectory is generated based on a center of a travel lane.

11. The method of claim 10, wherein the at least one agent trajectory is along the center of a travel lane.

12. A vehicle, comprising:
at least one processor, and
at least one non-transitory storage media storing instructions that, when executed by the at least one processor, cause the at least one processor to perform operations comprising:
receive, sensor data indicative of the environment surrounding a vehicle;
generate a segmentation mask indicative of at least one occluded area;
generate at least one hypothetical agent trajectory based on the at least one occluded area;
determine at least one agent generation point based on the at least one agent trajectory;
determine, whether a threshold distance from the at least one agent generation point to the vehicle is satisfied;
generate, based on the at least one agent generation point, at least one agent that is associated with at least one motion profile based on determining that the predefined threshold distance is satisfied;
plan a path of the vehicle based generating the at least one agent; and
control the vehicle according to the planned path.

13. (canceled)

14. The vehicle of claim 12, further comprising:
updating the at least one occluded area indicated on the segmentation mask from a previous time, based on a current state of the vehicle;
updating the at least one agent trajectory based on updating the at least one occluded area and an initial trajectory of the vehicle;
determining at least one updated agent generation point based on the updated at least one agent trajectory; and
determining that the at least updated one agent generation point does not correspond to a previously used agent generation point.

15. The vehicle of claim 12, further comprising:
determining at least one recurring agent generation point near the boundary of the at least one occluded area; and
generating at least one recurring agent associated with at least one motion profile based on determining the at least one recurring agent generation point.

16. The vehicle of claim 12, further comprising:
updating a position and a velocity of a generated agent based on its motion profile.

17. The method of claim 16, further comprising:
determining that an agent enters an area observable by the vehicle for a sufficient amount of time; and
removing the agent from future updates based on determining that the agent enters an area observable by the vehicle for a sufficient amount of time.

18. The vehicle of claim 12, wherein the threshold distance is calculated based on the sensing range of the sensors mounted on the vehicle.

19. At least one non-transitory storage media storing instructions that, when executed by at least one processor, cause the at least one processor to:
receive, sensor data indicative of the environment surrounding a vehicle;
generate a segmentation mask indicative of at least one occluded area;
generate at least one hypothetical agent trajectory based on the at least one occluded area;
determine at least one agent generation point based on the at least one agent trajectory;
determine, whether a threshold distance from the at least one agent generation point to the vehicle is satisfied;
generate, based on the at least one agent generation point, at least one agent that is associated with at least one motion profile based on determining that the predefined threshold distance is satisfied;
plan a path of the vehicle based generating the at least one agent; and
control the vehicle according to the planned path.

20. The computer readable medium of claim 19, further comprising:
updating the at least one occluded area indicated on the segmentation mask from a previous time, based on a current state of the vehicle;
updating the at least one agent trajectory based on updating the at least one occluded area and an initial trajectory of the vehicle;
determining at least one updated agent generation point based on the updated at least one agent trajectory; and
determining that the at least updated one agent generation point does not correspond to a previously used agent generation point.

21. The computer readable medium of claim 19, further comprising:
determining at least one recurring agent generation point near the boundary of the at least one occluded area; and
generating at least one recurring agent associated with at least one motion profile based on determining the at least one recurring agent generation point.
